(19) United States
(12) Patent Application Publication
(10) Pub. No.: US 2012/0133231 A1
(43) Pub. Date: May 31, 2012

(54) Axial gap type rotating apparatus and axial gap type generator

(75) Inventor: Yukihiko Hayakawa, Kofu-shi (JP)

(73) Assignee: NISCA CORPORATION, Minamikoma-gun (JP)

(21) Appl. No.: 13/137,608

(22) Filed: Aug. 30, 2011

(30) Foreign Application Priority Data
Nov. 30, 2010 (JP) 2010-267485

(51) Int. Cl. H02K 21/24

(52) U.S. Cl. 310/156.37

(57) ABSTRACT

The invention is to provide an axial gap type rotating apparatus for enabling downsizing and high output by causing the magnetic field to pass across the coils effectively in arranging the magnets and coils to oppose one another in the axial direction of the rotor shaft, in which in arranging pluralities of segment magnets and segment coils radially to oppose one another in the circumferential direction of the rotor shaft, each segment coil is comprised of an air-core coil having a non-winding portion in the center, a segment yoke piece of soft magnetic material is provided in the non-winding portion while being in non-contact with the winding, and the segment yoke pieces are arranged discontinuously in a separate state for each of non-winding portions of a plurality of segment coils.

### BACKGROUND OF THE INVENTION AND RELATED ART STATEMENT

1. Field of the Invention

The present invention relates to an axial gap type rotating apparatus such as an electric motor and generator in which pluralities of magnets and segment coils are radially arranged to oppose one another in the circumferential direction of a rotation shaft (or fixed shaft) with gaps formed in the axial direction.

2. Description of the Prior Art

Generally, in a rotating apparatus such as a motor and generator, permanent magnets are arranged in one of the stator and the rotor, coils are arranged in the other one to oppose, and the torque or electromotive force is output by rotation of the rotor. Particularly, this type of rotating apparatus has recently been used as an apparatus to obtain driving output concurrently with power generation as hybrid driving.

Conventionally, the axial gap type rotating apparatus has been known as such a rotating apparatus. The rotating apparatus is known as a rotating mechanism in which segment magnetic poles and segment coils are opposed to one another in the axial direction of the rotation shaft with gaps formed, and the segment magnets are rotated as the rotor. For example, Japanese Patent Application Publication No. 2009-33946 discloses the structure in which a rotation disk of soft magnetic material is integrally formed in the rotation shaft, segment magnets are arranged in the circumferential direction in the rotation disk, fixed disks (two disks in the Publication) are arranged in positions opposed to the rotation disk with a distance from the rotation disk, and the segment coils are arranged in the circumferential direction in the fixed disks.

In such a rotating apparatus in which the magnets and coils are arranged to oppose so as to drive and rotate the rotation shaft or to generate electricity, it is necessary that the magnetic field of the magnet is formed in the direction for passing across the coil. Therefore, known are the structure in which a pair of magnets are opposed to each other with the coils sandwiched therebetween, and the structure the magnet is disposed on one side, while the yoke of soft magnetic material is disposed on the other side with the coils sandwiched therebetween.

Generally, in order to obtain high output as a rotating apparatus, it is known increasing the line diameter of the coil or increasing the number of turns, and thus increasing the motor length and diameter, and both methods increase the coil capacity. When the space occupied by the coil is thus increased, the gap between magnets where the magnetic field is formed to pass across the coil is also increased. The increase in the magnet gap results in an increase in reluctance, reduces the magnetic flux, and is the detrimental effect in increasing output.

Meanwhile, smooth startup is required of this type of rotating apparatus, and it is also known that the segment coil is comprised of an air-core coil. However, conventionally, as disclosed in Japanese Patent Application Publication No. 2009-33946, a plurality of segment magnets is arranged in the circumferential direction in the rotation disk, and the segment coils are arranged in the fixed disk that is opposed to the rotation disk with the gap provided therebetween. Therefore, when the coil capacity is increased to obtain high output, the distance between magnetic poles increases to form the magnetic field with the coil sandwiched therebetween. Therefore, the reluctance increases, and there has been the problem that desired output is not obtained in spite of the fact that the apparatus is increased in size by increasing the coil capacity.

Then, to solve the aforementioned problem, the inventor of the invention arrived at the idea of magnetism-concentrating the magnetic field passing through the coil center (non-winding portion) of the air-core coil on the winding portion based on the knowledge that high output is obtained by increasing lines of magnetic force passing across the coil.

### OBJECT OF THE INVENTION

It is an object of the invention to provide an axial gap type rotating apparatus for enabling downsizing and high output by causing the magnetic field to pass across the coils effectively in arranging the magnets and coils to oppose one another in the axial direction of the rotor shaft.

### SUMMARY OF THE INVENTION

To attain the above-mentioned object, the invention is characterized in that in arranging pluralities of segment magnets and segment coils radially to oppose one another in the circumferential direction of the rotor shaft, each segment coil is comprised of an air-core coil having a non-winding portion in the center, a segment yoke piece of soft magnetic material is provided in the non-winding portion while being in non-contact with the winding, and that the segment yoke pieces are arranged discontinuously in a separate state for each of non-winding portions of a plurality of segment coils.

Further, the configuration will be described specifically. An axial gap type rotating apparatus, in which a stator (30) and a rotor (20) are arranged to oppose each other in the axial direction of the rotor shaft with a gap formed, is provided with a plurality of segment coils arranged radially in the circumferential direction of the rotor shaft in one of the stator and the rotor, and a plurality of segment magnets (23) arranged radially in the circumferential direction of the rotor shaft in the other one of the stator and the rotor.

Each of the segment coils is comprised of an air-core coil having a non-winding portion (32Co) in the center, in the non-winding portion is arranged a segment yoke piece (33) of soft magnetic material in non-contact with a winding, and the segment yoke pieces are radially arranged in a discontinuous state while being separate for each non-winding portion of each of the segment coils.

In the invention, pluralities of segment coils and segment magnets are arranged radially in the circumferential direction of the rotor shaft, each of the segment coils is comprised of an air-core coil, the segment yoke pieces of soft magnetic material in non-contact with the wiring are arranged in the non-winding portions in a discontinuous state while being separate for each non-winding portion, and therefore, the following effect is produced.

In arranging segment coils and segment magnets to oppose one another in the axial direction of the rotor rotation shaft with a gap formed, and rotating the rotor to obtain rotation output or electric power generation, the yoke piece of soft magnetic material is disposed in the non-winding portion in the coil center together with the coil between magnetic poles of the segment magnets passing across the coil. Accordingly, it is possible to concentrate the magnetic flux passing through the non-winding portion of the coil on the magnetic flux passing across the coil by the yoke piece.

Thus, in the invention, the yoke piece of soft magnetic material is provided between the magnetic poles opposed to each other with the coil therebetween, and therefore, even when the gap between the magnetic poles is increased, it is possible to increase the magnetic flux passing across the coil by magnetism concentration action of the yoke piece.

Further, in the invention, pluralities of segment coils are arranged in a layered manner in the axial direction of the rotor shaft, the coil group in the layered manner is displaced by a predetermined angle in the circumferential direction of the rotor shaft, and the yoke piece arranged in the non-winding portion of each of the segment coils thereby concentrates magnetism in the direction for passing across the coils of adjacent layers. By this means, it is possible to increase the magnetic flux passing across the coils in parallel with the axial direction, and to further increase output.

### BRIEF DESCRIPTION OF THE DRAWING

FIG. 1 is an exploded view of an axial gap type rotating apparatus according to the invention;

FIG. 2 is a sectional view of an assembly state of the apparatus of FIG. 1;

FIG. 3A is a view showing an arrangement state of segment magnets in a plane configuration in the apparatus of FIG. 1;

FIG. 3B is a view showing an arrangement state of segment coils in a plane configuration in the apparatus of FIG. 1;

FIG. 3C is a perspective view showing a configuration of a single segment coil in the plane configuration in the apparatus of FIG. 1;

FIG. 3D is a plane view of the configuration of a single segment coil in the plane configuration in the apparatus of FIG. 1;

FIG. 4 is a conceptual explanatory view showing a configuration of a rotor and a stator in the apparatus of FIG. 1;

FIG. 5A is a view showing a sectional configuration in one Embodiment (Embodiment 1) in the apparatus of FIG. 1;

FIG. 5B is an enlarged explanatory view of principal part in one Embodiment (Embodiment 1) in the apparatus of FIG. 1;

FIG. 6A is an enlarged explanatory view of principal part in a different Embodiment (Embodiment 2) in the apparatus of FIG. 1;

FIG. 6B is an explanatory view of a layer arrangement of segment coils in the different Embodiment (Embodiment 2) in the apparatus of FIG. 1;

FIG. 7A is an enlarged explanatory view of principal part in another different Embodiment (Embodiment 3) in the apparatus of FIG. 1;

FIG. 7B is an explanatory view of an aspect different from FIG. 7A in another different Embodiment (Embodiment 3) in the apparatus of FIG. 1;

FIG. 8 shows property experiment data of effective magnetic flux density of each Embodiment; and

FIG. 9 is a conceptual configuration view of a power generation system.

### DETAILED DESCRIPTION OF PREFERRED EMBODIMENT

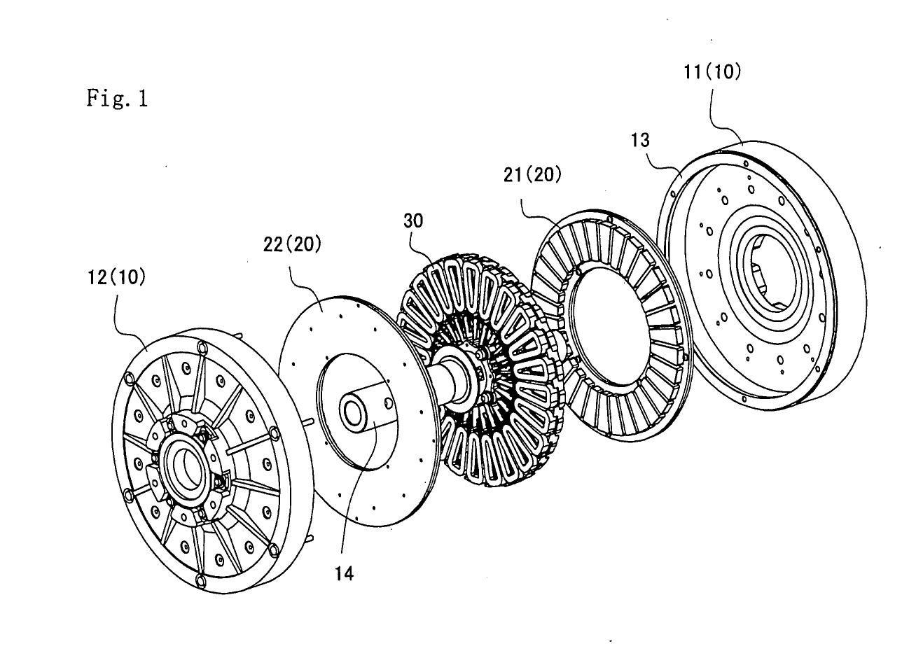

The present invention will be described below based on preferred Embodiments shown in figures. FIG. 1 is an exploded view of an axial gap type rotating apparatus according to the invention. The rotating apparatus shown in the figure is comprised of a housing 10, rotor 20 and stator 30. The housing 10 is formed of an upper frame 11 and a lower frame 12 each in the shape of a cup, and the frames are joined via sealing packing 13 by bolts or the like.

The rotor 20 and stator 30 are integrated into the housing 10. The structure is integrated as an outer rotor configuration or inner rotor configuration. The structure shown in the figure shows the outer rotor structure, but may be the inner rotor configuration. A fixed shaft 14 (rotor shaft; the same in the following description) is fixed to the housing 10, and the rotor 20 is bearing-supported rotatably by the fixed shaft 14, while the stator 30 is fixed to the fixed shaft 14. End portions of the fixed shaft 14 are fixed to the upper frame 11 and lower frame 12, and sealed by packing or the like. The fixed shaft 14 shown in the figure is integrally configured with the stator 30, described later, and is fixed to the housing 10, but the rotation shaft may be integrally formed in the rotor 20 to be axially supported rotatably by the housing 10. The fixed shaft 14 or the rotation shaft is referred to as a rotor shaft.

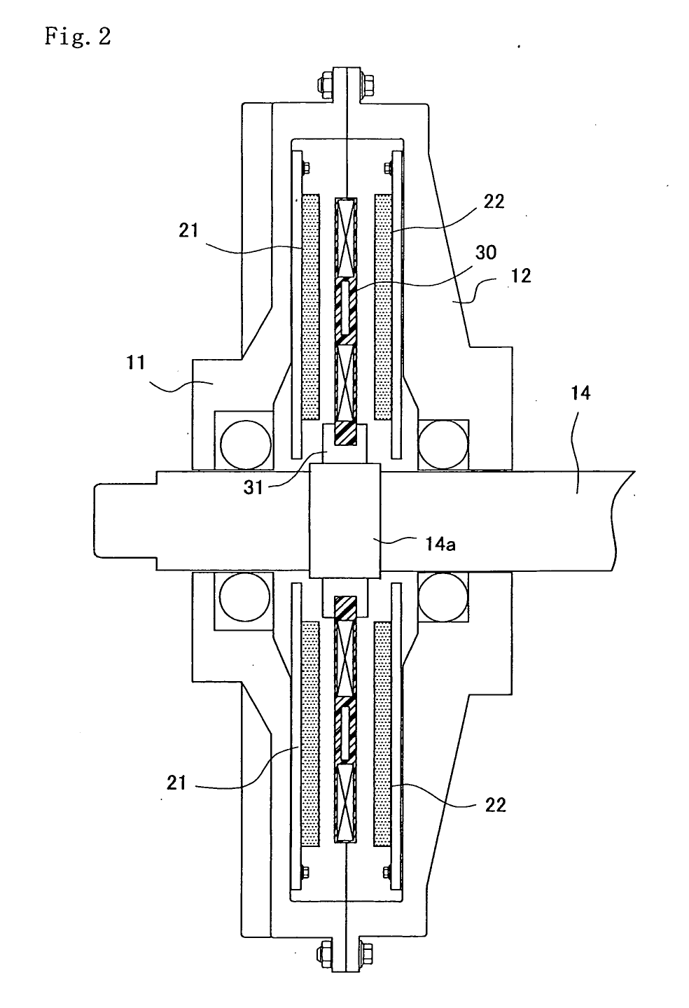

The rotor 20 is comprised of a pair of core yokes 21, 22 and segment magnets 23 (23a, 23b . . . 23n). The pair of core yokes 21, 22 are spaced a distance d1 in the axial direction (x-x direction in FIG. 2) of the rotor shaft (rotation shaft or fixed shaft) 14 and are axially supported to be rotatable, and the segment magnets 23 (23a, 23b . . . 23n) are fixed to each of the pair of yoke cores. Each of the core yokes 21, 22 shown in the figure is formed of a disk-shaped soft magnetic material, and a plurality of segment magnets 23 is bonded to each of opposed inner surfaces 21a, 22a with an adhesive or the like. The pair of core yokes 21, 22 are integrally combined with a joint member, and are coupled to an input shaft (or output shaft) described later.

The core yokes 21, 22 shown in the figure are respectively fixed to the upper frame 11 and lower frame 12, and the upper and lower frames are integrated by bolts. Nonmagnetic shield plates are provided in between the upper frame 11 and the core yoke 21 and between the lower frame 12 and the core yoke 22 to magnetically shield, or the core yokes and the upper and lower frames are magnetically integrated. Then, the upper frame 11 and the lower frame 12 are supported rotatably by the fixed shaft 14 with bearings 16, 17. Alternately, a pair of core yokes 21, 22 may be coupled integrally by a joint member without being fixed to the housing 10. The arrangement structure of the segment magnets 23 will be described later.

The stator 30 is comprised of a coil holder 31 and segment coils 32 (32a, 32b . . . 32m), and is fixed to the rotor shaft 14 fixed to the housing 10. The coil holder 31 shown in the figure is formed of a disk-shaped nonmagnetic resin. A sleeve-shaped collar 14a is integrally attached to the rotor shaft 14, and the disk-shaped coil holder 31 is fixed to a flange of the collar 14a. Then, the coil holder 31 is internally provided with the segment coils 32 by resin forming. The arrangement of the segment coils 32 will be described later.

In thus configured rotor 20 and stator 30, as shown in FIG. 2, the coil holder 31 is fixed to the fixed shaft 14, and the core yokes 21, 22 are rotatably supported by the fixed shaft 14. Then, an air gap with a distance d1 is formed between the pair of core yokes 21, 22, and the coil holder 31 is spaced a distance d2 from each of the core yokes. Further, the core yokes 21, 22 each configured in the shape of a disk and the coil holder 31 form gaps d1 and d2, and are arranged in parallel planes.

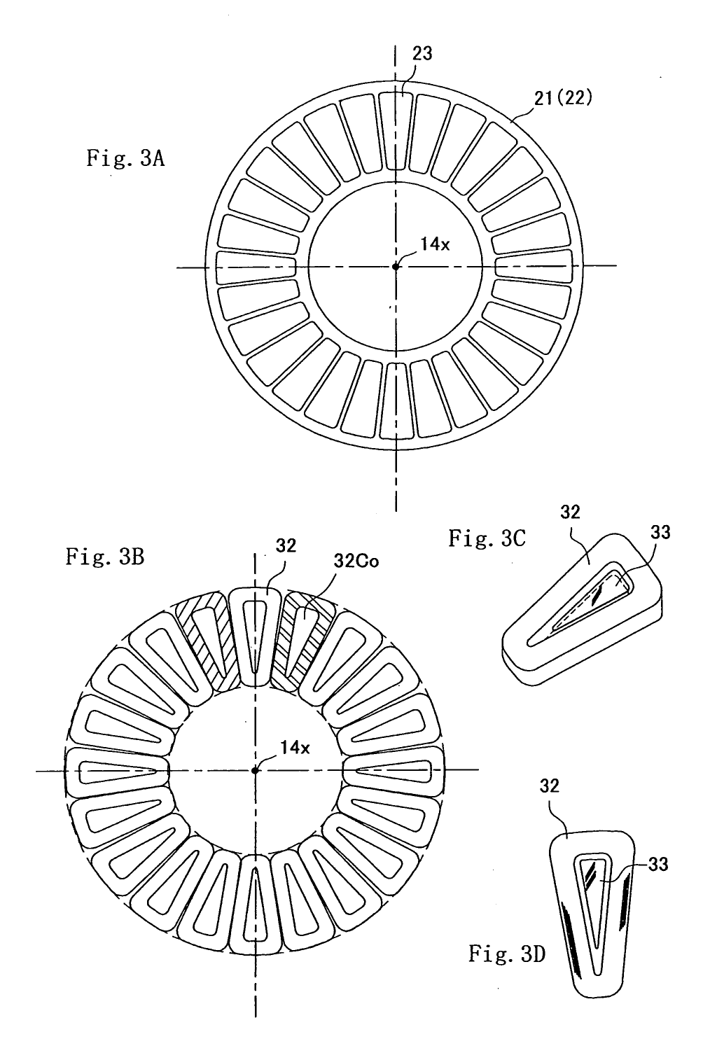

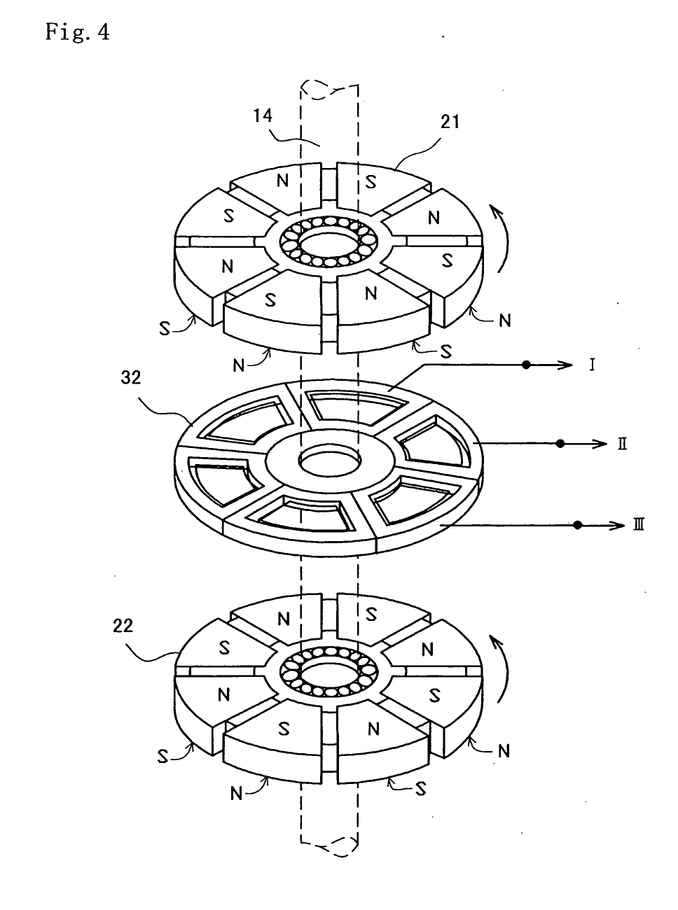

The arrangement relationship between the segment magnets 23 and segment coils 32 will be described below according to FIGS. 3A to 3D and FIG. 4. FIG. 3A shows the arrangement structure of the segment magnets 23, FIG. 3B shows the arrangement structure of the segment coils 32, and FIGS. 3C and 3D show the shape of a coil element. FIG. 4 shows the opposed arrangement of the segment magnets 23 and segment coils 32.

As the segment magnets 23, as shown in FIG. 3A, a plurality of segment magnets 23 (23a, 23b . . . 23n) is radially arranged with equal pitches around the shaft center 14x of the rotor shaft 14 as the center in the disk-shaped core yoke 21 (22). Each of the magnets is formed of a permanent magnet piece, and the magnetic poles are formed in the frontside and backside of the figure. The north pole and the south pole are alternately arranged in adjacent poles in the magnet pieces. In the apparatus shown in the figure, in relation to configuring the rotating apparatus for a generator, the number of segment magnets 23 is set at a multiple of 32, and is in the relationship of 4:3 with the segment coils 32 (a multiple of 24), described later.

As the segment coils 32, as shown in FIG. 3B, a plurality of coil elements 32 (32a, 32b . . . 32m) is radially arranged with equal pitches around the shaft center 14x of the rotor shaft 14 as the center in the disk-shaped coil holder 31. The number of coil elements shown in the figure is “24” (or a multiple of 24), and the number “m” of the coil elements and the number “n” of permanent magnet pieces are set at the number of the coil elements m: the number of permanent magnet pieces n=3:4.

FIG. 3C(3D) shows the shape of the coil element, and the coil element 32 is configured by winding a ribbon line or a wire line in the shape of a loop and has a non-winding portion 32Co in its center portion. Then, a segment yoke piece 33 (33a, 33b . . . 33m) is disposed in the non-winding portion 32Co of the core center while being in non-contact with the winding. The segment yoke piece 33 is formed of a plate-shaped member of soft magnetic material. The coil holder 31, coil elements 32, and yoke pieces 33 are integrally formed in the shape of a disk with a synthetic resin, for example.

The relationship in the segment magnets 23, segment coils 32 and yoke pieces 33 will be described below according to FIG. 4. FIG. 4 is a conceptual view showing the relationship among three components. As described previously, the segment magnets 23 are arranged in the pair of core yokes 21, 22 to oppose with a distance d1 therebetween. Then, a plurality of segment magnets 23 is arranged in each core yoke 21 (22). Then, the segment magnets 23 of the first core yoke 21 are set in the opposite pole relationship with the segment magnets 23 of the second core yoke 22 such that when one of the magnets is the north pole, the other one is the south pole. Accordingly, the magnetic pole is formed between the pair of core yokes 21, 22.

Meanwhile, the segment coils 32 are arranged between the pair of core yokes 21, 22. In this case, it is preferable that the segment coils 32 are spaced equal distances from each core yoke 21 (22). Further, the segment coils 32 are formed in one-layer structure in Embodiment 1, described later.

Meanwhile, the segment coils 32 are formed in two-layer structure in Embodiment 2, and thus, are formed of upper and lower layers in the axial direction in the same structure. Then, in the case as shown in the figure, the segment coils 32 (32a, 32b . . . 32m) arranged radially are provided with a three-phase output line (input line).

The first and second core yokes 21, 22 are supported in bearing 16 (17) by the fixed shaft 14 to be rotatable, and the segment coils 32 are fixed to the fixed shaft 14. Then, in the case of using as a generator, the input shaft (not shown) is coupled to the pair of core yokes 21, 22, and in the case of using as an electric motor, a current (three-phase current in the apparatus shown in the figure) is applied to the segment coils 32.

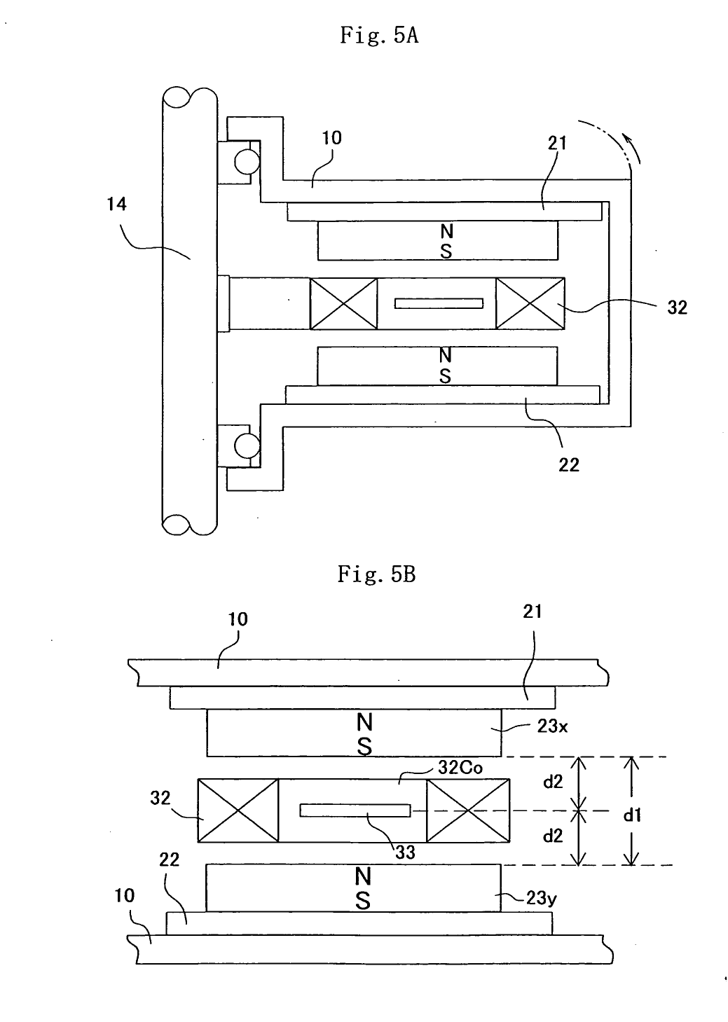

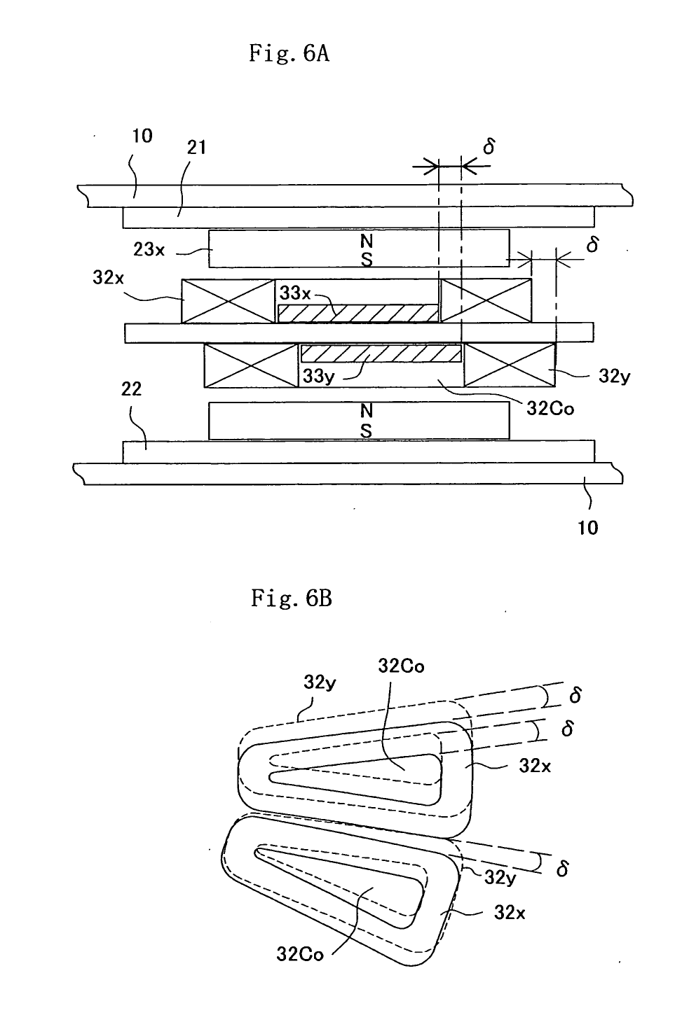

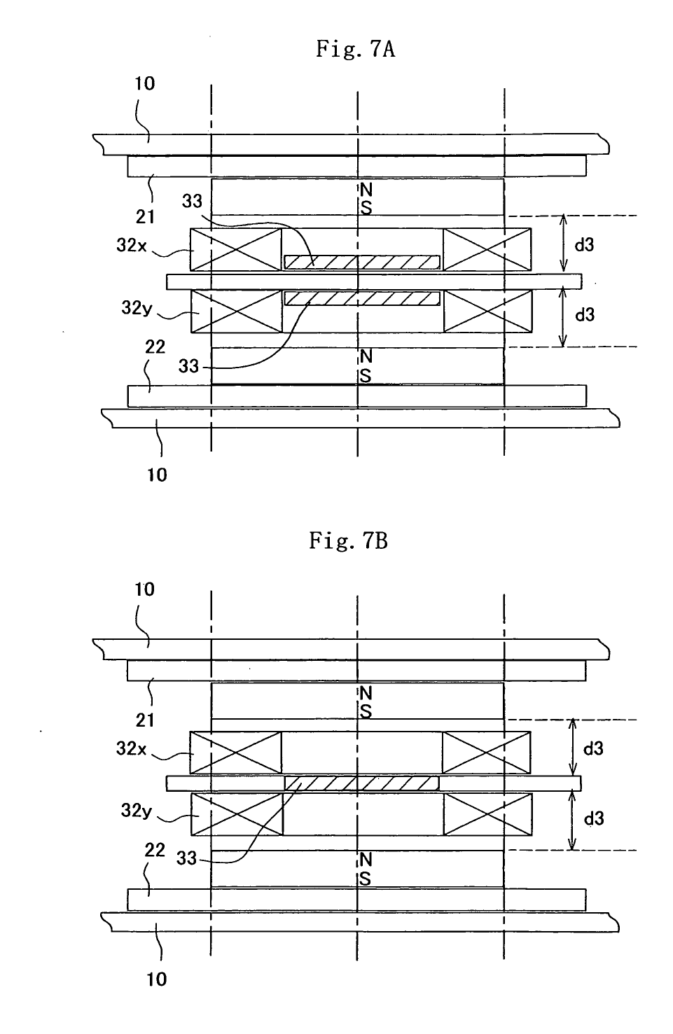

Specific Embodiments will be described according to the basic configuration of the invention as described above. FIGS. 5A and 5B show Embodiment 1, FIGS. 6A and 6B show Embodiment 2, and FIGS. 7A and 7B show Embodiment 3.

### Embodiment 1

The Embodiment as shown in FIGS. 5A and 5B shows the case where the segment coils 32 are configured in one-layer structure. The pair of core yokes 21, 22 are spaced a distance d1 and located in the fixed shaft 14. In each of the core yokes 21, 22 are arranged magnet pieces 23x, 23y to form mutually opposed magnetic poles. In between the first and second core yokes 21, 22 are arranged the coil elements 32 fixed to the fixed shaft 14.

The magnet pieces 23x, 23y are spaced an air gap d1 to form opposed magnetic poles, and the coil elements 32 are disposed in the center (d1/2). In each of the coil elements 32, the yoke piece 33 is disposed in the non-winding portion 32Co of the core center while being in non-contact with the winding. The yoke piece 33 is spaced equal distances from the pair of core yokes (22).

As described previously, the magnet pieces 23x, 23y, coil elements 32 and yoke pieces 33 are arranged radially in the circumferential direction of the fixed shaft 14, and particularly, the yoke pieces 33 are arranged radially in a discontinuous state while being separate for each non-winding portion 32Co of each coil element.

In such a configuration, as shown in FIG. 5B, the magnetic field generated between the magnet pieces 23x and 23y is as shown by dashed lines in FIG. 5B when the yoke piece 33 does not exist. However, in the Embodiment shown in the figure where the yoke piece 33 exists between the magnet pieces 23x and 23y, the magnetic field concentrates in magnetism on the yoke piece 33 as shown by solid lines in FIG. 5B. By this means, the effective magnetic flux density passing across the coil increases, and it is possible to obtain high output.

### Embodiment 2

The Embodiment as shown in FIGS. 6A and 6B shows the case where the segment coils 32 are configured in two-layer structure. A first coil layer 32x and second coil layer 32y are arranged in the axial direction of the rotor shaft 14 in between the pair of core yokes 21, 22 configured as in above-mentioned Embodiment 1. The yoke piece 33x, 33y is arranged in the non-winding portion 32Co of each coil element. Then, in the first coil layer 32x and the second coil layer 32y is formed a phase difference with an offset amount δ in the rotation direction of the rotor. In other words, the first coil layer 32x and the second coil layer 32y are arranged as upper and lower layers in the axial direction of the rotor shaft, and are offset by a distance δ in the coil element of the first coil layer 32x and the coil element of the second coil layer 32y.

FIG. 6B shows the offset state, where the coil element (solid line in FIG. 6B) of the first coil layer 32x and the coil element (dashed line in FIG. 6B) of the second layer 32y are displaced from each other by the distance δ, and a phase difference is formed in the rotation angular direction of the rotor. By thus configuring, the yoke piece 33x disposed in the non-winding portion 32Co of the first coil layer 32 deflects the line of magnetic force to the coil of the second coil layer 32y.

### Embodiment 3

The Embodiment as shown in FIGS. 7A and 7B is a modification of Embodiment 1 as shown in FIGS. 5A and 5B, and shows the case where the segment coils 32 are configured in two-layer structure as in the Embodiment in FIGS. 6A and 6B. In the Embodiment as shown in FIG. 7A, the yoke piece 33 is formed in the non-winding portion of each of the first coil layer 32x and the second coil layer 32y without any phase difference being formed. Meanwhile, in FIG. 7B, one yoke piece is disposed between the first coil layer 32x and the second coil layer 32y without any phase difference being formed. The other configuration is the same as in Embodiment 2 and is assigned the same reference numerals to omit descriptions.

### [Output Property in Each Embodiment]

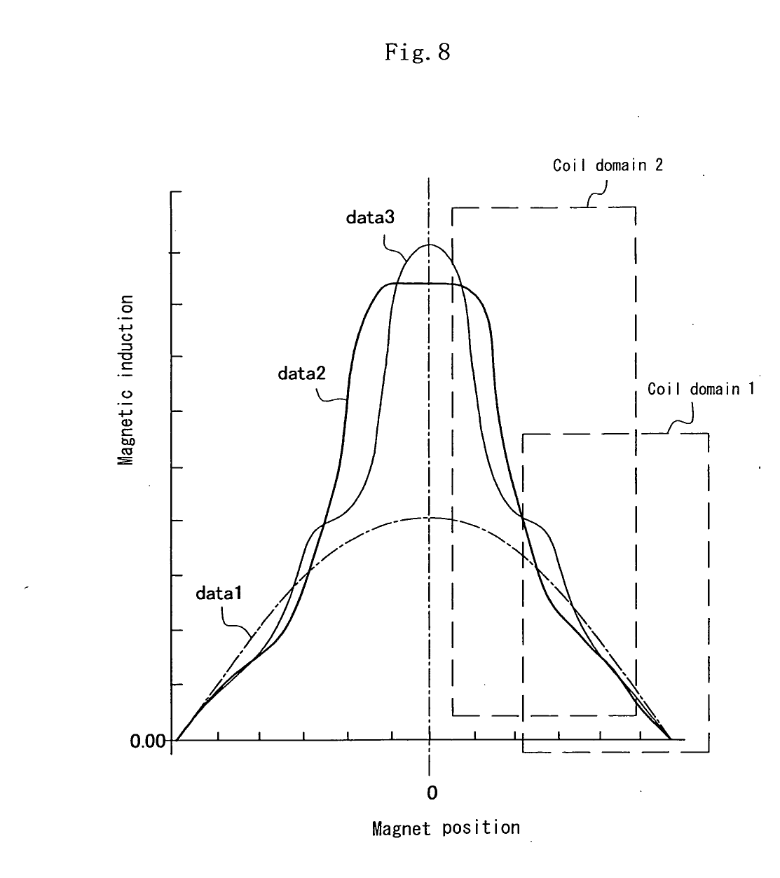

FIG. 8 shows the property of effective magnetic flux density of each Embodiment. In FIG. 8, the horizontal axis represents the position in the magnet, the dotted lines in the center show the center thereof, and the vertical axis represents the magnetic flux density in the center between the magnets. In FIG. 8, data 1 represents the magnetic flux density distribution of the conventional structure without the segment yoke being provided, and data 2 represents the magnetic flux density distribution with the structure of Embodiment 2 adopted. Further, data 3 represents the magnetic flux density distribution with the structure of Embodiment 3 adopted.

With respect to data 1 without the segment yoke being provided, the peak value increases by almost two times in data 2 having the segment yoke, and further, in data 3, there are increases in the peak value and increases in the entire use range. Then, the magnetic flux of the coil in Embodiment 3 is an average of magnetic fluxes of from coil domain 1 to coil domain 2 up to Embodiment 2, and the effective magnetic flux increases by almost two times.

### [Power Generation System]

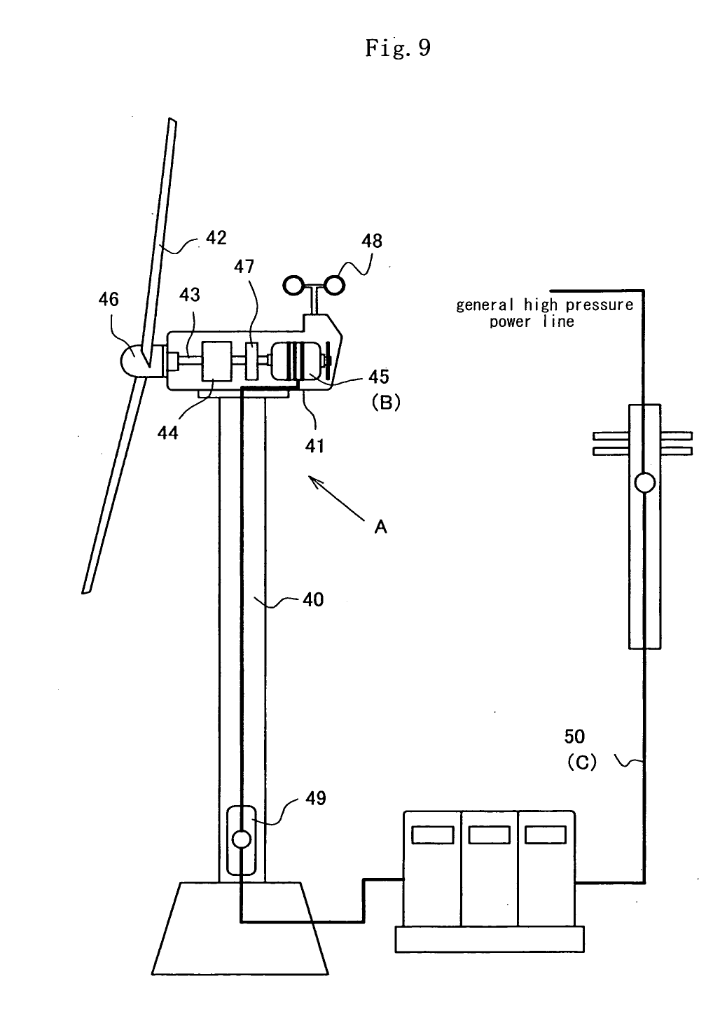

A power generation system will be described which uses the rotating apparatus of FIGS. 1 to 8. FIG. 9 is a conceptual configuration diagram of a power generation system. The power generation system as shown in FIG. 9 is comprised of a [driving source A], [power generation part B] and [output part C]. The driving source A transforms energy from a power generation source such as wind power, water power and vapor into rotational motion. The system shown in the figure indicates wind power generation, and the driving source A is comprised of a tower frame 40, nacelle 41 mounted on the frame, and blades (wind power blades) 42 rotatably attached to the nacelle 41.

The tower frame 40 is configured firmly so as to position the blades 42 in a predetermined height position above the ground, although there are differences according to installation conditions of the system. The nacelle 41 is attached to the tower frame 40 to be rotatable in the wind power direction. Into the nacelle 41 are integrated a driving rotation shaft 43, hub 41, speed-increasing gear 44, and generator 45 (power generation part B).

The driving rotation shaft 43 is provided with a hub 46, and the blades 42 are fixed to the hub 46. The blades 42 are configured in the shape of a blade excellent in efficiency for transforming wind power into turning force. Then, the driving rotation shaft 43 that rotates by the blades 42 is coupled to the generator 45 via the speed-increasing gear 44 and brake 47. “48” shown in the figure denotes an anemometer, and measures wind power at that point in time to transmit to a control part. “49” shown in the figure denotes a control panel, and “50” shown in the figure denotes a general high pressure power line of the output part C.

In addition, this application claims priority from Japanese patent application No. 2010-267485 incorporated herein by reference.

What is claimed is:

1. An axial gap type rotating apparatus in which a stator and a rotor are arranged to oppose each other in the axial direction of a rotor shaft with a gap formed, comprising:
a plurality of segment coils arranged radially in a circumferential direction of the rotor shaft in one of the stator and the rotor; and
a plurality of segment magnets arranged radially in the circumferential direction of the rotor shaft in the other one of the stator and the rotor,
wherein each of the segment coils is comprised of an air-core coil having a non-winding portion in the center, in the non-winding portion is arranged a segment yoke piece of soft magnetic material in non-contact with a winding, and the segment yoke pieces are radially arranged in a discontinuous state while being separate for each non-winding portion of each of the segment coils.

2. The axial gap type rotating apparatus according to claim 1, wherein the winding forming each of the segment coils and the segment yoke piece are formed in a flat shape.

3. The axial gap type rotating apparatus according to claim 1, wherein the rotor has a pair of core yokes spaced a distance in the axial direction of the rotor shaft to oppose each other,
the plurality of segment magnets is attached to at least one of the pair of core yokes,
the stator has a fixed board arranged between the pair of core yokes,
the plurality of segment coils is attached to the fixed board, and
the segment yoke pieces are arranged in the fixed board so that a magnetic field generated between the pair of core yokes passes through the segment yoke pieces.

4. The axial gap type rotating apparatus according to claim 3, wherein the pair of core yokes and the segment yoke pieces are arranged in parallel planes spaced a distance from each other.

5. The axial gap type rotating apparatus according to claim 3, wherein a plurality of layers of the plurality of segment coils is arranged in a layered manner in the axial direction of the rotor shaft, and
one of the plurality of layers of segment coils is offset arranged with respect to the other one of the layers so as to form a phase difference of a predetermined angle in the circumferential direction of the rotor shaft.

6. The axial gap type rotating apparatus according to claim 5, wherein in the segment coils configured in the plurality of layers, the segment yoke piece is disposed in the non-winding portion of each of segment coils forming each layer.

7. The axial gap type rotating apparatus according to claim 5, wherein in the segment coils configured in the plurality of layers, the segment yoke piece is disposed between layers.

8. The axial gap type rotating apparatus according to claim 1, wherein the segment coils and the permanent magnets are arranged radially in the circumferential direction around the rotor shaft as the center to oppose one another, and the number of segment coils and the number of segment magnets are configured in the ratio of 3:4.

9. An axial gap type generator comprising:
an apparatus frame;
a stator having a rotor shaft fixed to the apparatus frame;
a rotor bearing-supported by the apparatus frame to be rotatable;
first and second core yokes, spaced a distance in the axial direction of the rotor shaft, disposed in the rotor;
a plurality of segment coils arranged radially around the rotor shaft as the center in the stator; and
a plurality of permanent magnets arranged radially around the rotor shaft as the center in each of the first and second core yokes,
wherein a plurality of permanent magnets in the first core yoke and a plurality of permanent magnets in the second core yoke are arranged so that respective magnet poles oppose each other and form a magnetic field in the axial direction of the rotor shaft,
the plurality of segment coils is arranged between the first and second core yokes with a gap formed so that the magnetic field formed by the permanent magnets passes across the segment coils,
each of the plurality of segment coils is comprised of an air-core coil having a non-winding portion in the core center,
a segment yoke piece of soft magnetic material is disposed in each non-winding portion,
the segment yoke pieces are arranged in a discontinuous state while being separate for each non-winding portion of each of the segment coils, and
the rotor is coupled to an input shaft.
